(19) United States
(12) Patent Application Publication
(10) Pub. No.: US 2004/0167906 A1
(43) Pub. Date: Aug. 26, 2004

(54) System consolidation tool and method for patching multiple servers

(76) Inventors: Randolph C. Smith, Canton, MI (US); Linda S. Richards, Snellville, GA (US); Janet R. Ritzer, Atlanta, GA (US); Mary Beth Titman, Lawrenceville, GA (US)

Correspondence Address: HEWLETT-PACKARD DEVELOPMENT COMPANY, Intellectual Property Administration, P.O. Box 272400, Fort Collins, CO, 80527-2400, US

(21) Appl. No.: 10/374,217

(22) Filed: Feb. 25, 2003

(51) Int. Cl. G06F 17/00

(52) U.S. Cl. 707/100

(57) ABSTRACT

A method and a tool simplify the analysis and maintenance of program products installed on plural computers. Product version information is gathered from each of a plurality of computers of a similar type. This information is then reorganized into one or more groups each containing the information gathered from a plurality of the computers such that the computers within each group have installed thereon program products the versions of which are upgrade compatible. The information in each group is used to guide the process of maintaining and upgrading the program products installed on the computers whose product information is within that group.

### BACKGROUND OF THE INVENTION

The present invention relates generally to the field of computer program installation and maintenance. More particularly, it relates to the installation and management of computer programs, of updates to programs, and of program repair patches on multiple machines, particularly on families of machines that are similarly configured.

The development and maintenance of computer programs is an ongoing task that continues over time. Prior to formal release, program development passes through multiple alpha and beta versions. But program repair and revision does not cease when a program is released for sale (or license) and general installation. It continues on. Many versions of a given program may be released over time, some minor and some major. In addition, different versions may be developed and released that are compatible with different operating systems and different releases of the same operating system. Program versions may be released in 16-bit forms and in 32-bit forms.

To make program maintenance even more complicated, “patches” are released for software. A “patch” is somewhat similar to a “new version,” but typically a “patch” is a specific “fix” for one or more specific problems in a given program. When first released, a patch may be unreliable. Multiple patches for the same program may later on be replaced by single newer patches. A given patch for a program may be compatible with some versions of an operating system, but not with other versions of that same operating system. Likewise, a given patch may be compatible with some versions of a given program but not with other versions of the same program.

Needless to say, accounting for programs, program versions, and program patches can get quite complicated, particularly in installations having many servers or many work stations. Differing computers may have varying sets of software and patches installed upon them. Even when a group of computers are supposed to be configured the same, it is not safe to assume that they are all configured the same

To assist the system's manager with this accounting, many computer system's operating systems now have “registry” systems, where programs, program versions, and patches are automatically registered when they are installed.

Taking advantage of such a registry, and with reference to FIG. 1, a collection script 114 can be run on each computer (server 1 at 102, server 2 at 104, etc.) to gather into what is called a “product specific information” (or “PSI”) file 202 (FIG. 2) information descriptive of all the programs, versions, file sets, and patches that are installed on any given computer. For example, from the computer server 1 at 102, the collect script 114 can gather from the computer's registry (not shown) a PSI file 1 shown at 108. This PSI file 108 may be conveyed (over the dotted path 109 in FIG. 1) to some form of patch selection tool 132 which can assist those who administer and maintain a given system (hereinafter called “maintainers”) in studying the condition of the server 1 and in selecting new patches for that system. For example, a set of new patches may be gathered with the aid of the patch selection system 132 and placed into a patch depot 136 which is installed on the server 1 at step 138.

Typical of patch selection tools is that disclosed in U.S. Pat. No. 6,477,703 (Nov. 5, 2002). Briefly described, that tool retrieves from a computer's PSI file a list of its programs, their versions, and any installed patches. It also retrieves from a patch set database 400 (FIG. 4) lists of recommended patches that one may wish to install on the computer. Finally, it produces a list of patches (and possibly programs or updated versions of programs) to be installed. From this list, one can generate a depot containing the patches, programs, and program updates that are to be installed and then install these on the computer.

But if each of hundreds or thousands of individual computers must be cared for in this one-at-a-time manner, the maintenance task becomes quite time and labor consuming. Accordingly, efforts have been made over the past several years to speed up this process. One simple effort at speeding up this process is to take all of the PSI files 108, 110, . . . and 112 from a family of servers (or a family of workstations, but not both) and then simply lump together, or combine, their individual PSI files into one single file. Then the file's contents can be presented in a single spreadsheet view, listing all installed file sets and all installed patches, as a guide to the maintainers, who can review what file sets are installed on each computer, what versions of the operating system each computer has, and which patches. This can aid the maintainer in conforming the computer members of the family to each other prior to installing new patches. The combined PSI file (possibly after manual editing) can then be fed on to some form of patch selection tool and used to generate a patch depot 136 for all of the machines in a given family.

The above strategy definitely saves time, but it is risky. It does not check to see if the computers whose PSI files are combined truly are configured in the same, or at least in compatible ways; it does not draw one's attention to ways in which the configuration of individual computers may need to be corrected or changed; and it may combine all the PSI files into one single combined file, when a careful analysis would reveal subtle ways in which the computers may vary that preferably calls for the generation of more than one set of merged PSI files.

### SUMMARY OF THE INVENTION

One embodiment of the invention relates to a method and tool for simplifying the analysis and maintenance of program products installed on plural computers. The method and the tool both gather product version information from each of a plurality of computers of a similar type. The gathered information is then reorganized into one or more groups each containing the information gathered from a plurality of the computers such that the computers within each group have installed upon them program products the versions of which are upgrade compatible. The information in each group is used to guide the process of maintaining and upgrading the program products installed on the computers whose product information is within that group.

### BRIEF DESCRIPTION OF THE DRAWINGS

FIG. 1 is a block diagram of an embodiment of the invention in overview illustrating how PSI files taken from multiple computers may be validated, displayed in tabular form, mastered into merged PSI files, and then used in reconfiguring the computers;

FIG. 2 presents the data structure of PSI files that are generated from computers and later merged together in one embodiment of the invention;

FIG. 3 presents a flow diagram of the process of performing consistency and validation checks on a family of PSI files utilized in one embodiment of the invention;

FIG. 4 presents a linked data diagram of the program patch contents of a patch set database suitable for use in an embodiment of the invention;

FIG. 5 presents a diagram of a database containing a set of iPatch set keys associated with product identifiers in accordance with an embodiment of the invention;

FIG. 6 presents a flow diagram of the routine used in one embodiment of the invention to generate product tables with links to related file sets and also patch tables with links to related replacement patches as one or more spreadsheets;

FIG. 7 presents a flow diagram of a mastering system used in one embodiment of the invention to combine many validated PSI files together into a smaller number of merged PSI files;

FIG. 8 presents a flow diagram of pass one of the mastering process, an automated process used in one embodiment of the present invention.

FIG. 9 presents a screen snapshot of user input screens, used during pass two of the mastering process, that enable a maintainer to review and to modify proposed sets of products to be represented in merged PSI files in one embodiment of the invention;

FIG. 10 presents a screen snapshot of an “Add Depot” screen that is used by a maintainer to define an additional set of merged PSI files in the embodiment of FIG. 9;

FIG. 11 presents a screen snapshot of an “Add Product” screen that is used to add an additional product specification to a set of merged PSI files in the embodiment of FIG. 9;

FIG. 12 presents a screen snapshot of a “Resolve Conflicts” screen that appears when the mastering system encounters product specifications within a potentially merged set of PSI files that need version adjustment in an embodiment of the invention;

FIG. 13 presents a flow diagram of the final steps performed by the mastering system, following pass one and pass two, to generate one or more merged PSI files in an embodiment of the invention;

FIG. 14 presents a screen snapshot of the product and patch tables generated by one embodiment of the invention in the form of a spreadsheet; and

FIG. 15 is a continuation of FIG. 14.

### DETAILED DESCRIPTION OF THE EMBODIMENTS SYSTEM OVERVIEW

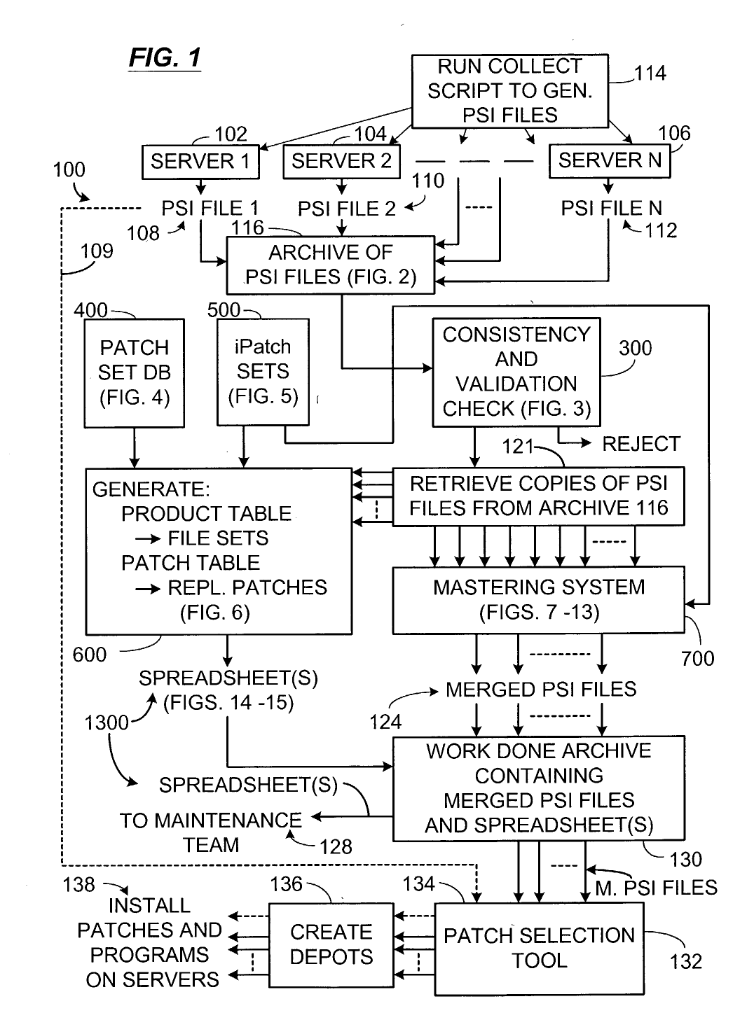

FIG. 1, presents an overview of a system consolidation tool and method 100 which is an embodiment of the present invention. The tool 100 is shown being applied to a family of servers 102, 104, . . . , and 106. While servers are shown, the computers could just as well be personal computers or workstations. There could be just a few computers, or there could be thousands of them. A collect script 114 is run on each of the servers 102 (etc.) to generate a PSI file 108, 110, . . . , and 112 for each of the servers 102, 104, . . . , and 106. These PSI files are then combined into a single archive file, which on UNIX systems is typically a TAR file, while on PC workstations it would typically be a ZIP file, both of which are well-known and widely used.

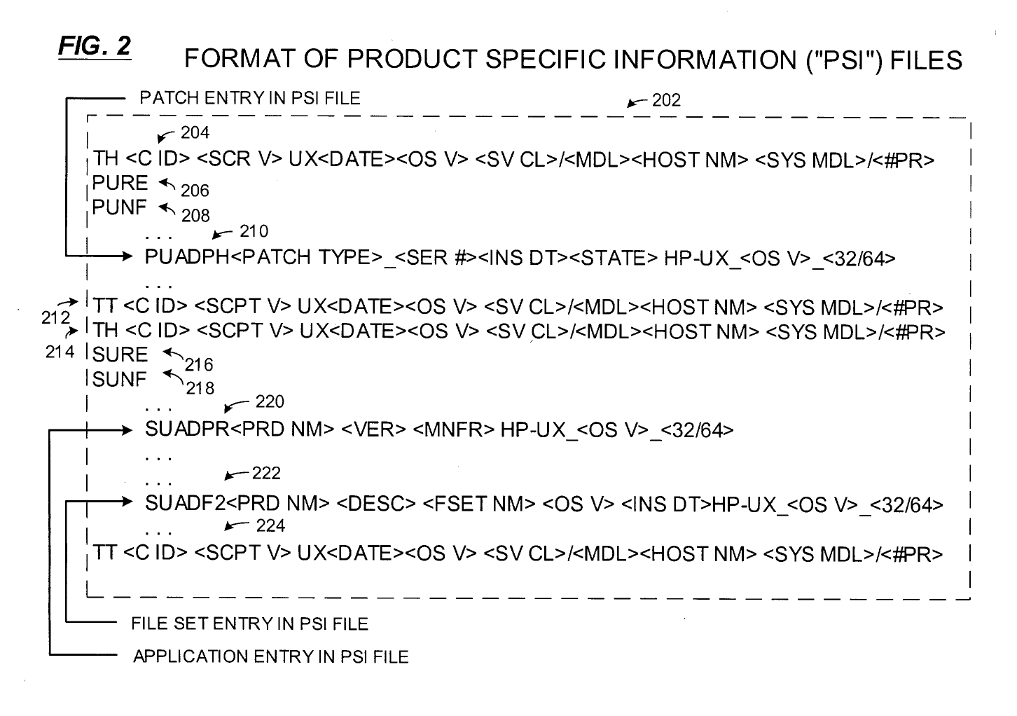

Examples of greatly simplified and shortened PSI files are presented in the appendices A, B, and C. These three PSI files are used to illustrate the way in which an embodiment of the invention works. They have been simplified and shortened to keep this description as simple and as easy to understand as possible. A real PSI file would typically be 20 to 40 pages in length when printed in this manner. The data structure of these PSI files is illustrated in FIG. 2 at 202 and is explained at a later point. Briefly described, the PSI files contain a line of data identifying every computer program product installed upon the server from which the file is extracted. It also contains a line of data identifying every file set that was installed upon the server to install each product. And it contains a line of data identifying every patch installed into the computer's file sets, patching some files and replacing other files.

Each of these PSI files can be analyzed, using a patch selection tool 132 or manually, and then used to guide a maintainer in first understanding and then in correcting and updating the server or workstation or other computer from which each PSI file was extracted. The disclosed embodiment of the present invention introduces the process of analyzing a larger set of PSI files to see which servers or other computers can be managed as a set or group, rather than individually. Then the number of PSI files is reduced to a much smaller number of what shall be called merged PSI files 124 each of which can be used by a maintainer to understand and then manage, correct, and update a small group of several or a large group of many computers almost as easily as one computer.

First, the archive of PSI files 116 is checked to see if all the files, and thus the computers whose configurations they represent, are sufficiently consistent with each other to be good candidates for merger of their PSI files. For example, the operating system versions and platforms must be consistent throughout all of the PSI files. In this embodiment, any inconsistencies are reported, and the set of PSI files is rejected.

After validation, copies of the PSI files are un-archived at step 121. A spreadsheet generator 600 analyzes the PSI files and generates a series of tables in spreadsheet form that enable the maintainer to study the configuration of each computer and note discrepancies and irregularities in their configurations. The generator 600 combines the PSI file data with data obtained from a patch set database 400. It also draws upon an iPatch set database 500 which defines the versions of programs and other software products that are mutually compatible for patching and maintenance.

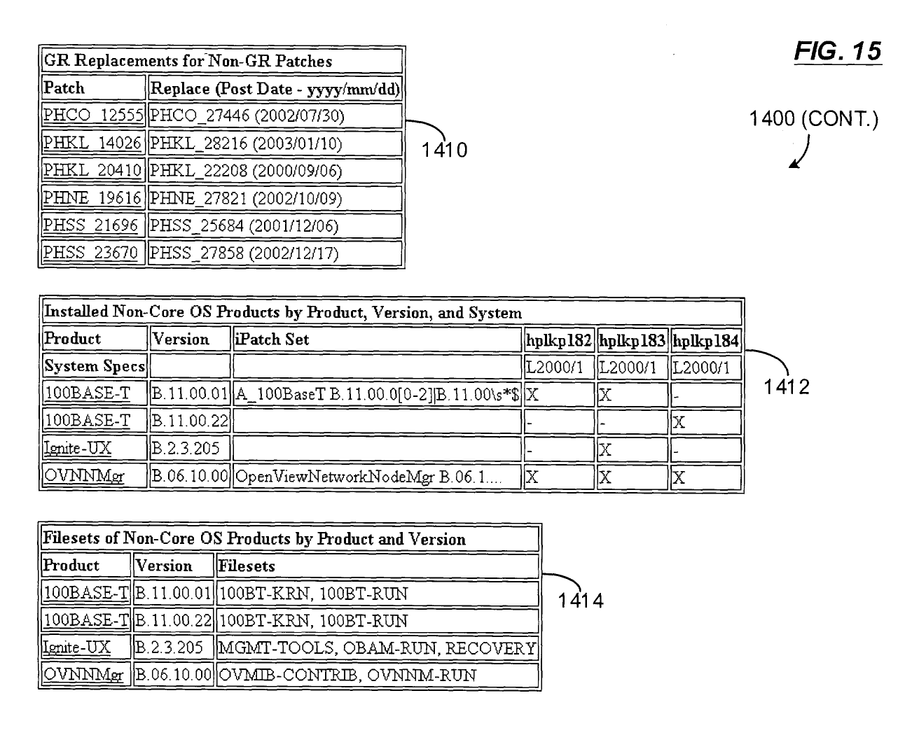

The spreadsheets 1300 generated by the generator 600 include a product table 1412 (FIG. 15) that defines, by product name and version, what products are installed on each computer. iPatch information included in the table 1412 defines which versions of products are compatible for the purpose of merging their patches and applying the same patches to differing versions. And each product entry is linked to a table 1414 of the file sets that define each product.

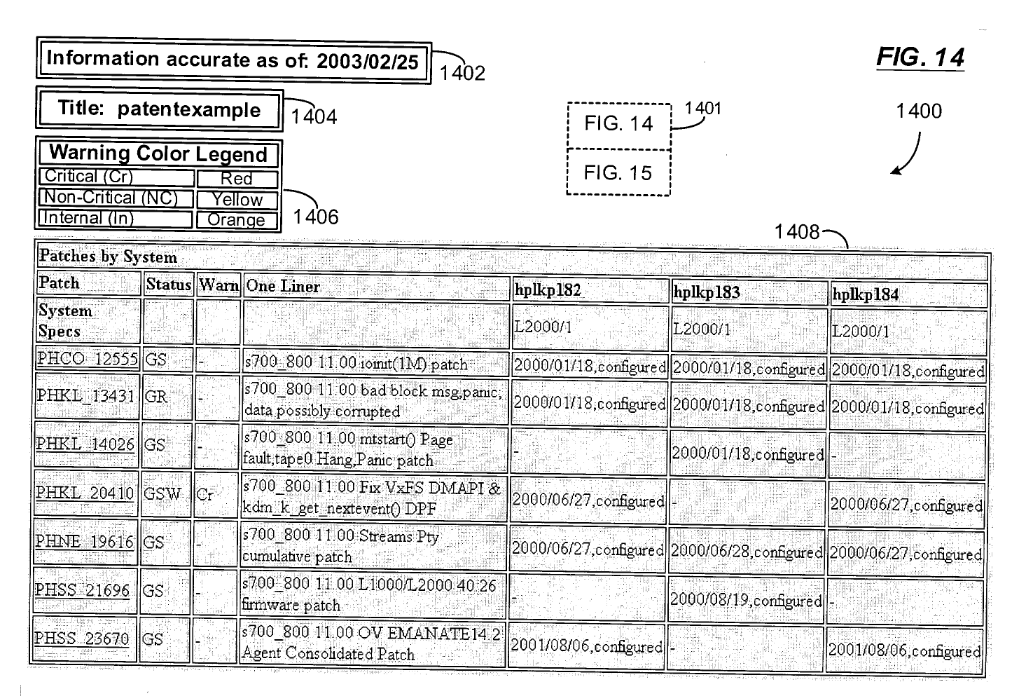

The spreadsheets also include a patch table 1408 (FIG. 14) which lists all of the patches presently installed on each machine. And through use of searches of the patch set data base 400, a link is established from each patch to any available suggested replacement patches, presented in a table 1410 (FIG. 15), guiding the maintainer in making decisions on system upgrades. The spreadsheets 1300 are stored within a work done archive 130 from which they may later be extracted and studied by the maintenance team 128.

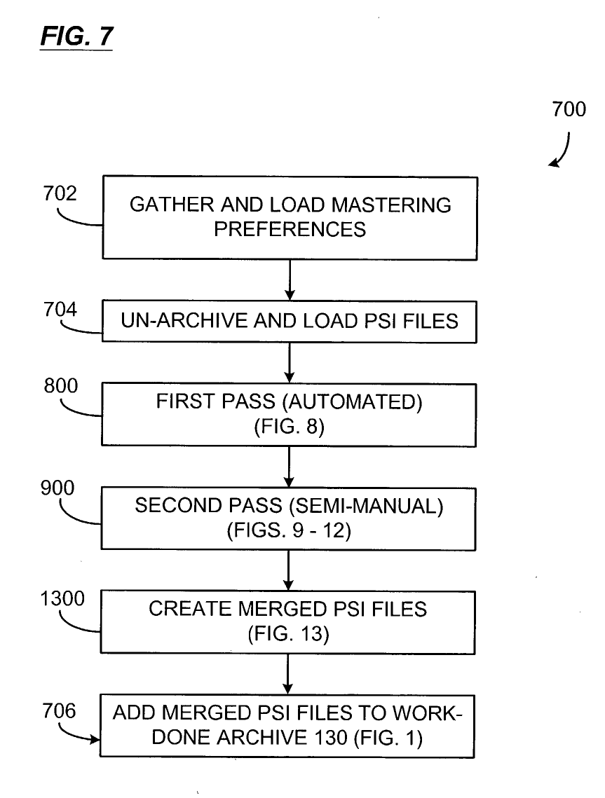

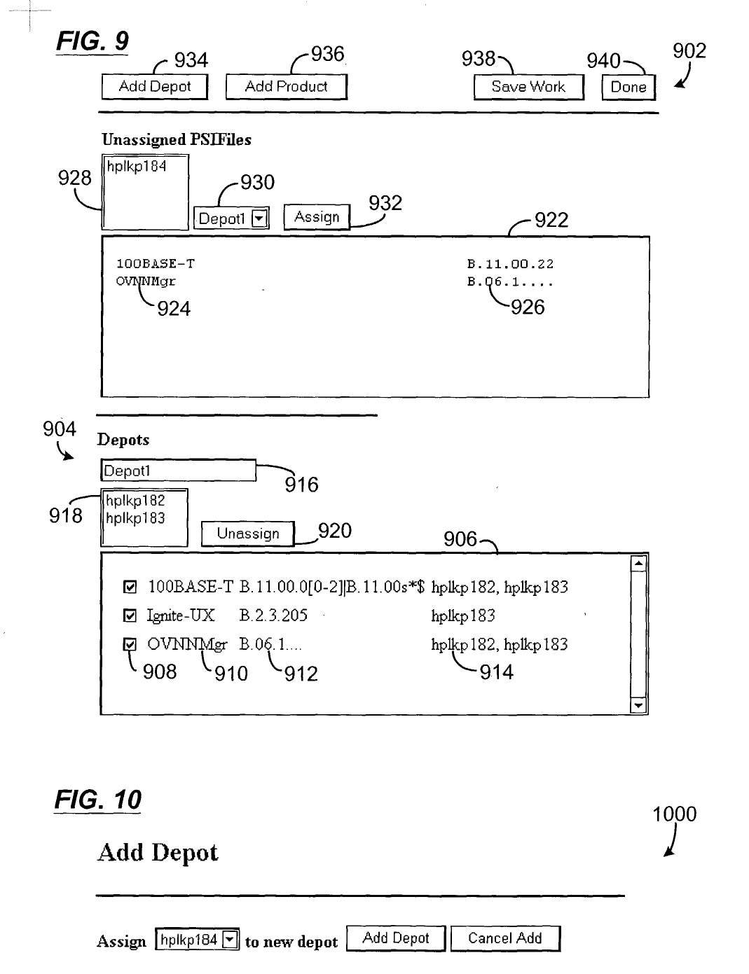

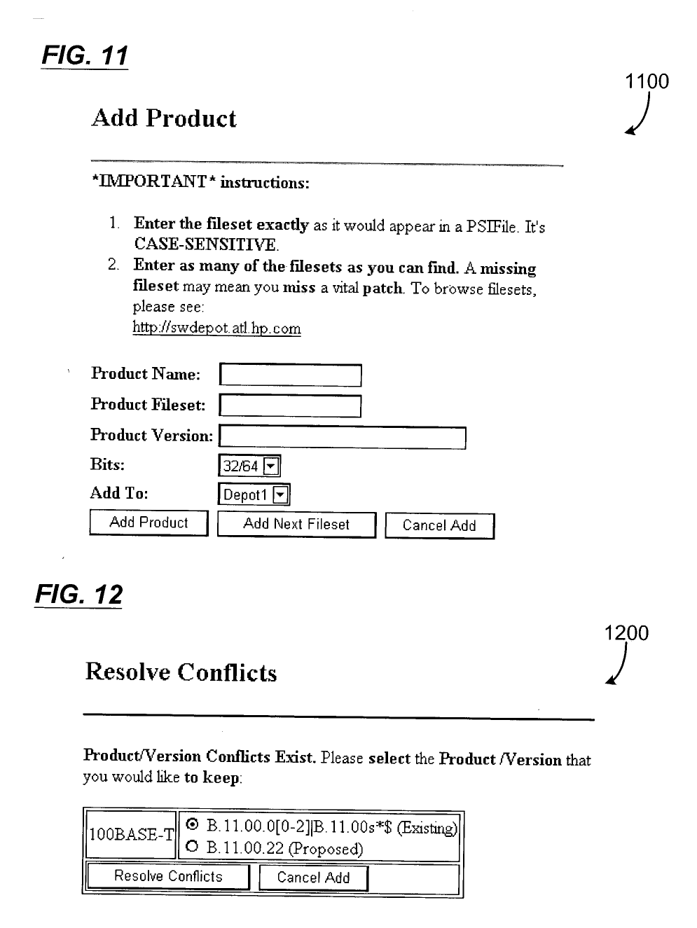

The validated PSI files are also presented to a mastering system 700 along with the IPatch sets for further analysis and study and processing. The mastering system 700 (FIG. 7) performs a first pass 800 which sorts the PSI files into preliminary groups or sets of compatible file sets for possible later merging. Then the maintainer is presented with these sets, described as “depot” sets or “depots” (each displayed in a scrollable screen window 904 shown in FIG. 9), since these sets are normally used to define the creation of computer system update depots 136— compacted sets of files arranged for automatic installation on multiple computers. But the mastering system, in its user interface (FIGS. 9 and 10), talks of computers (see the computer names hplkp182 and hplkp183 at 918 in FIG. 9, for example) and of products (see the product names 910 and 924 in FIG. 9). The maintainer is also given the opportunity to create additional depots for sets of computers, prompting the user (1200 in FIG. 12) to resolve product version conflicts in such depots. And the maintainer can also request the addition of new products to a given depot (1100 in FIG. 11).

After receiving the input of the maintainer, adjusting and fine-tuning the depots and their contents, the mastering system intelligently regenerates merged PSI files 124 and places them into the work done archive 130 along with the spreadsheets 1300.

The merged PSI files 124 can be studied to guide the maintainer through the process of maintaining, upgrading, and repairing whole classes of computers. They provide a useful organizing tool whereby entire classes of computers may be maintained together, rather than individually. All the machines represented by a merged PSI file do not need to contain the same set of programs. It is only necessary that to the extent the computers do have the same programs installed, their versions need to be compatible for patching and updating. As an option, the mastering system can include in the merged PSI files those patches that are installed on each and every associated computer. The maintainer may choose to omit all patch information from the merged PSI files, allowing them to focus solely upon products installed.

Another useful option is for the maintainer to instruct the mastering system to include, along with program product information, computer model and number of processor information, thus causing all of the computers gathered into each depot to be identical in their system configuration and number of processors. As another option, the maintainer may instruct the mastering system to disregard the compatibility tests and generate a single merged PSI file for all of the computers. This single file, organized by software product and version, is an excellent tool for system maintenance and may be used to guide the creation of depots 136 of programs for installation on the computers and on other computers.

Structure and Data Contents of the PSI Files

With reference to FIG. 2, each PSI file 108, 110, . . . , 112 (FIG. 1) is organized as a series of lines each containing a header word followed by blocks of data separated by underscores or spaces as is indicated in FIG. 2. There are two sets of multiple data lines in a PSI file.

The first set of multiple data lines includes one patch entry 210 for each program patch that has been installed on a given computer. This line has the header “PUADPH” followed information for each patch:

PUADPH—the patch line header

<PATCH TYPE> patch type, which can be

CO—combined

KL—kernel

NE—network

SS—subsystem

<SER #>—patch serial number

<INS DT>—patch installation date

<STATE>—patch state, which can be, for example:

configured—the patch is somehow configured after installation

installed—the patch is installed without any configuration

failed—the patch did not install correctly

HP-UX—the operating system's name

<OS V>—the o. s.'s version—“B. 11.00” or “B.11.00.01”

<32/64>—width (in bits) of OS calls—“32,” “64,” or “32/64”

The second set of multiple data lines contains two different types of multiple data lines: a first type of data line identifies each installed program “product;” and a second type of data line identifies each installed set of files or “file set.” Normally, several “file sets” must be installed to install a “product.”

The first type of data lines in the second set are application entries 220 which are organized as follows:

SUADPR—a line header identifying an application or product entry

<PRD NM>—the name of the product or program

<DESC>—a description of the product

<VER>—the product version

<MNFR>—the product's manufacturer

HPUX—the name of the operating system

<OS V>—the operating system version

<32/64>—width (in bits) of OS calls—“32,” “64,” or “32/64”

The second type of data lines positioned together at the end of the second set, are file set entries 222 in the PSI file which are organized as follows:

SUADF2—a line header identifying a file set entry

<PRD NM>—the name of the product which this file set is part of

<DESC>—a description of the file set (manuals, help, etc.)

<FSET NM>—the name of the file set

<OS V>—the version of the operating system

<INS DT>—the file set's installation date

HP-UX—the name of the operating system

<OS V>—the operating system version

<32/64>—width (in bits) of OS calls—“32,” “64,” or “32/64”

As illustrated in FIG. 2, the two sets of data lines are each bracketed by header and footer lines. The first set (the patch data lines) are preceded by a header line 204 having the line header “TH” and two lines 206 and 208 respectively containing the line headers “PURE” and “PUNF”, and are followed by a trailer line 212 beginning with “TT”. The second set of data lines (the application and data set lines) are preceded by an identical header line 214 having the line header “TH” and two lines 216 and 218 respectively containing the line headers “SURE” and “SUNF”, and are followed by an identical trailer line 224 beginning with “TT”.

All the header and trailer lines contain the same data all of which relates to the computer from which the PSI file was extracted, as follows:

TH—the line header for a header line

<C ID>—the contract identifier of the customer

<SCR V>—version of collect script that created the PSI file

UX<DATE>—date the PSI file was created

<OS V>—operating system version

<SV CL>/<MDL>—the class and model of the computer

<HOST NM>—the name assigned to the server or workstation

<SYS MDL>/<#PR>—model and number of processors

Consistency and Validation Check

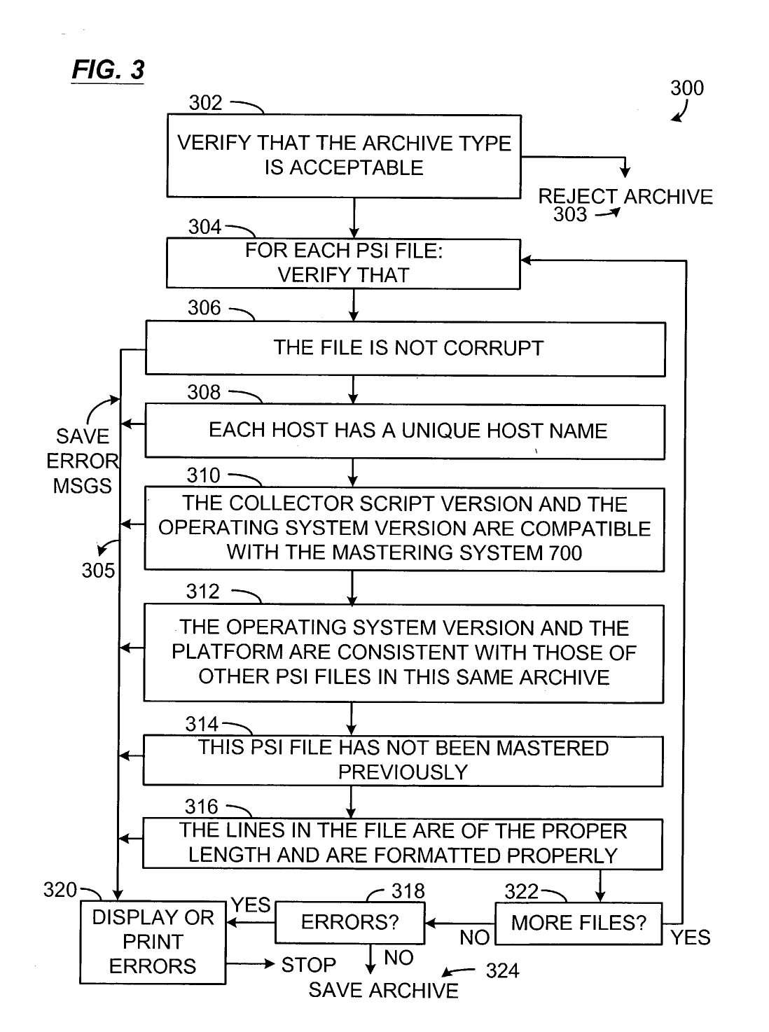

Referring now to FIG. 3, the details of the PSI file consistency and validation check are shown. This process begins at step 302, where the archive 116 is first examined to see if it is acceptable. If anything is wrong with it, the archive 116 is rejected at 303—the checking process halts.

Next, the archive 116 is opened, and then each of the PSI files 108, 110, . . . , and 106 is copied out and is subjected to a series of steps. First, at step 304, each file is tested for any possible corruption. Line headers are checked for integrity. Next, a test is made at 308 to insure that each host (the servers 102, 104, . . . , and 106) has its own unique “host” name. This is important, because within the mastering system, the host names, extracted from the <HOST NM> field of the PSI file headers 204, 214 and trailers 212, 224 are used to identify each computer as well as each PSI file set of data. These names also survive into the merged PSI files 124, as can be seen in Appendix D (described at a later point).

At step 310, a check is made of the collector script versions and of the operating system versions to see if they are compatible with the mastering system 700. Then, at step 312, the mutual compatibility of this set of PSI files is checked out by testing to see if the operating system version and platform of all the computers are consistent with those of the other computers represented in the set of PSI files. For example, the first number in the “<SV CL>” field in the PSI file header line 204 (FIG. 2) is an “8” in the case of a server class computer and a “7” in the case of a workstation class computer. These two classes of computers are incompatible, and their PSI files may not share an archive in this embodiment. Next, at step 314, a test of the PSI file header information determines whether any of the PSI files had been mastered previously. Non-mastered PSI files contain the name of a host in their headers and footers. Finally, the length of the lines in the file are checked to see that they are of the proper length and are formatted properly.

If any errors are found at step 318, these are presented in error messages which flow over the path 305 to be displayed or printed at step 32. The process repeats at step 322 until there are no more PSI files to examine, at which point the files are saved back within the archive at step 324.

iPatch SETS

The iPatch sets relate multiple compatible product versions together in a way that, once properly set up, may be verified automatically by the mastering system. It is also understandable to maintainers, and accordingly iPatch sets may optionally be included in the product table, as can be seen in the third column of the table 1412 in FIG. 15.

The iPatch sets are sets of compatible versions of a product. An iPatch group is defined by means of an expression, written as a “Unix Regular Expression,” that maps itself onto all the compatible version numbers and names. The use of Unix Regular Expressions is explained in the book by Jeffrey Friedl entitled, “Mastering Regular Expressions” (2^{nd} Edition, July 2002, O'Reiley & Associates, Sebastobol, Calif.). Very briefly described, experts examine the range of version numbers or identifiers that share compatibility with the same program patches. They then write out regular expressions that match all the compatible identifiers but not the incompatible identifiers. Very briefly described, regular expressions use: an asterisk to represent the previous character repeated any number of times; a period to represent any ASCII character (printable or not); a vertical line to represent “OR”; an ampersand to represent “AND”; a dollar sign to represent the end of a string; a “\s” to represent a space; and so on. Thus, any number of spaces at the end of a line might be represented by “\s*$:. iPatch uses such expressions to define which version numbers form a compatible set of version numbers for purposes of compatible program patching and forming depots that serve as the basis for merging PSI files. FIG. 5 presents a simplified example of a product name associated with an iPatch set key at 500. For more details, see Appendix E, where the actual structure of the iPatch sets is presented along with an example.

Patch Set Data Base

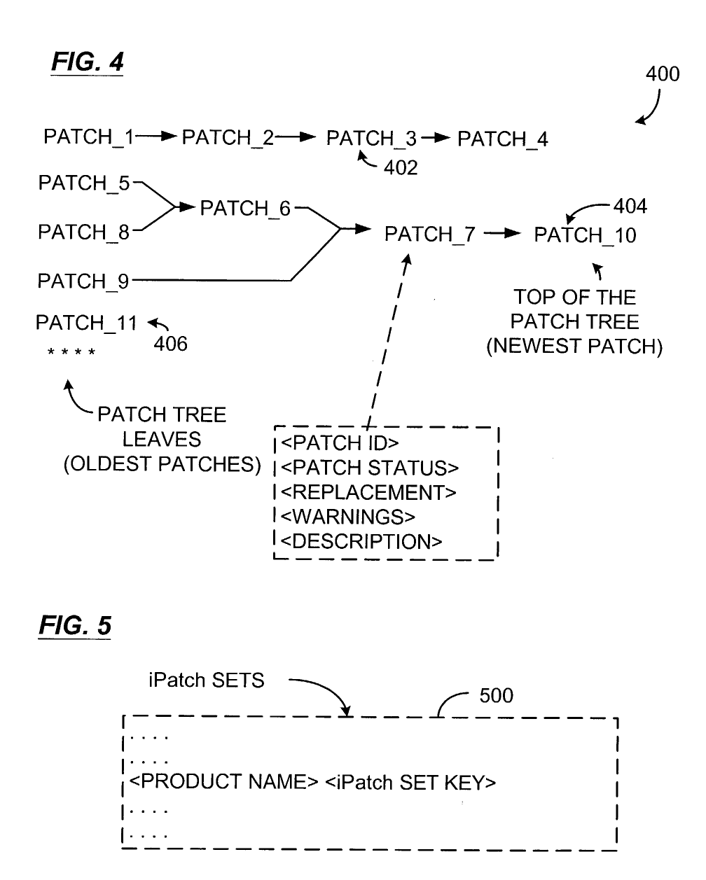

In FIG. 4, a database 400 is shown that contains “patch trees” of related sets of program patches. Three patch tree sets 402, 404, and 406 are shown. The patch tree set 402 contains a series of four patches PATCH_{—}1, PATCH_{—}2, PATCH_{—}3, and PATCH_{—}4 all intended for use in patching the same program. These patches are ordered from left to right in accordance with when they were created, the patch PATCH_{—}1 being the earliest patch created, the patch PATCH_{—}2 being the next earliest, and so on. Each newer patch in the patch tree 402, proceeding from left to right, contains all the repairs and features of the preceding patch in the same family tree, and additional repairs and/or features. Thus, in general, a newer patch is the more desirable patch to use. Sometimes, as shown in the patch tree 404, the earliest patches are multiple patches, such as PATCH_{—}5, PATCH_{—}8, AND PATCH_{—}9. A more recent single patch, such as the PATCH_{—}10, will contain all of the repairs and corrections of all of the earlier patches that appear in the same patch tree. As shown relative to the illustrative patch PATCH_{—}7, each patch has associated with it a patch ID number, a patch status (“GR” for “general release, “GS” for “general release but superseded,” “GSW” for “general release but superseded with a warning, “SR” for “special release,” “SS” for “special release superseded,” and so on), a path replacement indication (“PHCO_{—}12555”, “PHCO_{—}27446”, “PHKL_{—}14026”, “PHKL_{—}28216”, etc.), possibly a warning (“Cr” or critical, “NC” or non-critical), and an English language description explaining what the patch does.

When looking for a replacement for a presently installed patch, one can search the patch description fields seeking a patch that remedies a particular user problem, or one can start at the position of an installed patch in a set of patches and walk forward, through the patch tree from the leaves towards the roots, seeking out the newest replacement patch for that particular program and file set. This is how the spreadsheet generator 600 comes up with replacement patches in the hypertext linkages between the patch entries in the table 1408 (FIG. 14) and the replacement patches in the table 1410 shown in FIG. 15.

Generating the Spreadsheet Tables

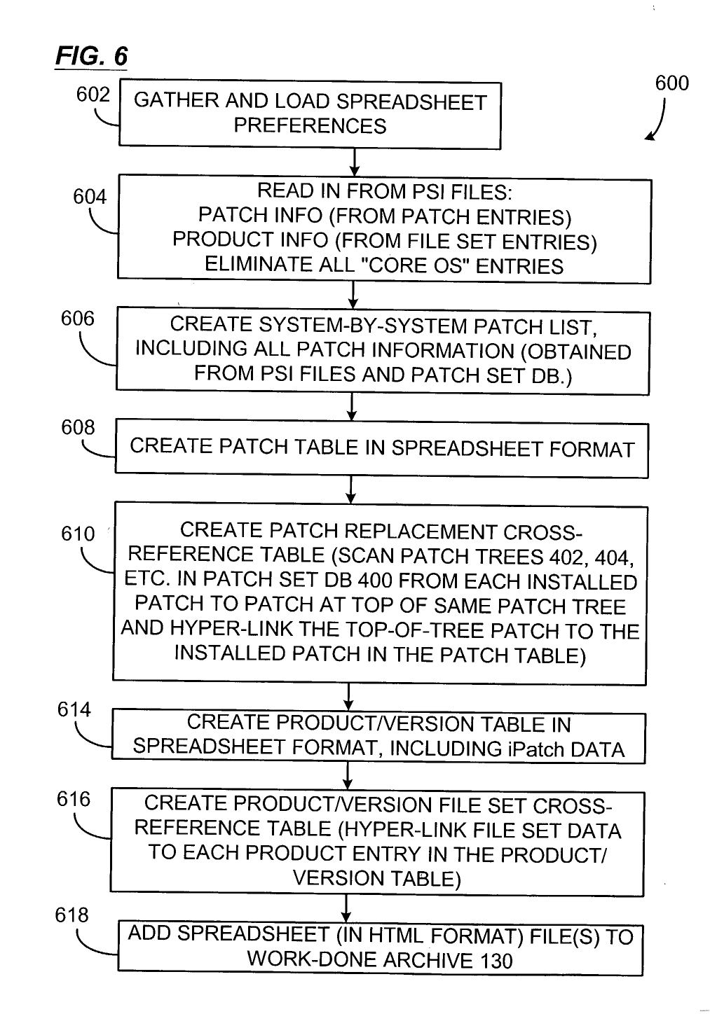

FIG. 6 presents the steps that are carried out by the spreadsheet generator 600. Its primary task is to generate the two tables 1412 (FIG. 15) and 1408 (FIG. 14) and some additional tables that are hyperlinked to these two tables. FIGS. 14 and 15 are normally joined together to form a single spreadsheet, as is indicated at 1401 if FIG. 14.

The table 1412 presents a column for each computer, with the computer's name at the top of each column, as shown, and with the columns ordered alphabetically from left to right by computer name. Each row then represents a product for which one or more file set lines appear within one or more of the computer's PSI files 108, 110, . . . , and 112, with a product name and version appearing at the left end of each row, and with the rows organized alphabetically by product and version from top to bottom. At the option of the maintainer, an iPatch Set column to the right of the product name and version columns presents the iPatch set expression for any version, if one exists, this indicating the range of versions that are compatible for program patching purposes and for the purpose of merging PSI files in the mastering system 700. The exemplary spreadsheet table entries shown in FIGS. 14 and 15 are all generated from the three exemplary PSI files presented in Appendices A through C, which (as has been noted) are simplified examples for the purposes of illustrating the invention and how it works. Each entry in the table 1412 at the intersection of a product/version row with a host column is an “X” if that product is installed on that computer or a “-” if that product is not installed on that computer.

A table 1414 (FIG. 15) presents a list of the file set lines of the PSI files that correspond to the file sets which are installed on the computers. Each product name in the product table 1412 is hyper-linked in such a manner that when one clicks upon a product name in the left-most column of the table 1412, one sees displayed a listing of all of the file sets for that particular product and version found in the file set table 1414. The installation of a product is accomplished by installing its several file sets. Thus, this table indicates which file sets are required to install a given product. The file set table 1414 is sorted first by product, and within the same product by version, and within the same version by file set name.

The patch table 1408 (FIG. 14) may be contained in the same spreadsheet with the product table 1412. At the option of the maintainer, the two tables may be generated in separate spreadsheets. The table 1408 also devotes a column to each computer, with the computer's host name at the top of each column, and with the columns arranged alphabetically by host name from left to right. Each row after the first row represents a patch that is installed upon at least one computer. The first column presents the letters “PH” followed by the patch type, an underscore character, and the patch serial number (as was explained in the discussion of FIG. 2 above). The second column presents the patch's status obtained from the patch set database (see the examples of patch status codes presented above in the preceding section—other patch status codes may also be used here).

If there is any warning associated with the patch, an optional third column can indicate the warning (“Cr” for “critical” or “Non-CR” for “non-critical,” for example, or “-” if there is no warning). If the warning table is not selected, the warnings are then placed into a separate spreadsheet with some additional information added. A fourth column then presents a brief, human-generated description of each patch.

The remaining vertical columns then indicate which patches are installed on which computers. At the intersection of a patch row with a computer column, a “X” indicates the patch is installed upon the computer, while a “-” indicates it is not installed upon the computer. Optionally, the “X” may be replaced by the patch's install date, by an indication of the installation state of the patch, or by both of these. The installation state of the patch can be “installed,” “configured” (if the patch was configured following its installation), or “failed” (the patch failed to install properly).

Another table 1410 indicates, for each patch, whether a more up-to-date replacement for that patch can be found in the patch set DB 400 (FIG. 4). A hyperlink is established between the name entry for each patch in the patch table 1408 and the corresponding entry in the replacement patch table 1410.

Note that both the patch table 1408 (FIG. 14) and the product table 1412 (FIG. 15) contain a first row after the column title row that is labeled, at the far left, as the ““System Specs” row. This row specifies which type of system specification each host computer conforms to. In this example, all of the system specifications are “L2000/1”, meaning all of the computers are models “L2000” and each has one microprocessor installed. The sorting of the columns is also done by host name.

Referring now to FIG. 6, the spreadsheet generator 600 begins by either loading itself with a file containing the maintainer's previously-defined preferences for the spreadsheet tables, or by asking the maintainer for his or her preferences, or both at step 602. The spreadsheet and table preference options were described in the preceding paragraphs. These preferences are provided, since some tables may be supplied directly to customers, while others may be supplied to technical staff members, and they have different needs for information.

At step 604, copies of the PSI files are retrieved from the archive (step 121 in FIG. 1) and are read into the spreadsheet generator 600. In this embodiment the patch information entries are read in, and the file set entries are also read in. The product entries are disregarded, since the file set entries contain all of the necessary product information. To simplify the spreadsheet, all entries for what may be called “core operating system” products—things that are always installed on every computer without exception, since they are part of the core of the operating system—are discarded and are not included in any of the spreadsheet tables. This greatly simplifies and reduces the size of the tables without any loss of useful information to the maintainer.

At step 606, the patch list is created from the patch entries in all of the PSI files. This information is organized and sorted into the patch table 1408 (FIG. 14) which was described above. At step 610, the patch replacement cross-reference table 1410 (FIG. 15) is created from information obtained from the patch set database 400 (FIG. 4). The entries in this table 1410 are hyper-linked to the corresponding patch entries in the main patch table 1408.

The product and version table 1412 is created at step 614, and iPatch information from the iPatch sets 500 (FIG. 5) is optionally added to this table as well. At step 616, the file set table 1414 (FIG. 15) is created and is hyper-linked to the corresponding entries in the main product table 1412 (FIG. 15) as has been described. And finally, at step 618, the one or more spreadsheets 1300 are generated in HTML form, for convenient viewing with either a spreadsheet program or with a web browser, and the spreadsheets 1300 are placed into the work done archive 130 from which they may be later retrieved and used by the maintenance team at 128 (FIG. 1).

Mastering System

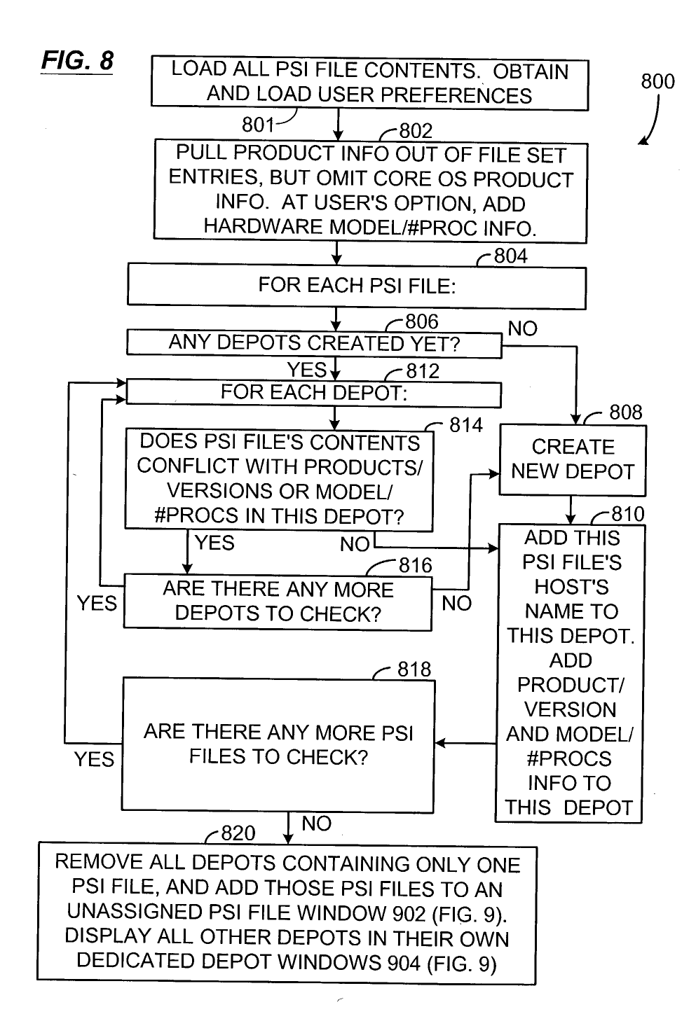

The details of the mastering system 700 are presented in overview in FIG. 7. The details of the first pass 800 through the PSI files carried out by the mastering system are presented in FIG. 8, and a detailed program listing of the first pass is presented in Appendix E, written in the language Perl. This Perl program carries out the steps set forth in FIG. 8 and described below. It also generates the data that is to be displayed (during the second, semi-manual pass 900 of the mastering system 700) first in Perl data structures, and then the Perl program translates these Perl data structures into corresponding JavaScript data structures for each set of material that is to be displayed in one of the windows 902, 904, (etc.) as is illustrated in FIGS. 9 and 10. These JavaScript data structures are then passed, as files, to a Cold Fusion implementation of the user interface system illustrated in FIGS. 8 and 9. (The Cold fusion program is supplemented in small part by a small Foxpro 3.0 database which comes with the Cold Fusion product.) Accordingly, the Cold Fusion program generates a web page with the data structures generated by the Perl program to control the formatting and the displaying of data in the windows 902, 904, (etc.) during the second (semi-manual) pass 900 through the data. The details of this relatively complex data structure format conversion process are presented fully in Appendix F.

With reference to FIG. 7, the mastering system 700 begins by gathering from the user, or loading from a previously-created file, the user preferences that will govern the mastering process.

One option is to ignore all differences between the PSI files by not comparing the differing versions of the products. This causes all of the PSI files to be merged together into a single merged PSI file, relying upon the patch selection tool and the operating system software to make whatever adjustments are needed when depots of programs are later created for installation on the various computers.

If this option is not selected, then during its first pass 800, the PSI files are loaded at 704, and then the mastering system 700 during its first pass 800 will normally group together and merge the PSI files containing references to compatible versions of products, separating PSI files containing references to incompatible versions of programs into separate “depots” for display in one or more depot windows such as the illustrative window 904 (FIG. 9). The iPatch expressions determine which versions of products are deemed to be compatible, as has been explained above. In FIG. 9, the windows generated during the second pass, when the maintainer is given an opportunity to view and to alter the assignment of computers to depot groups, is presented on the assumption that the three PSI files presented in Appendices A, B, and C, presumably generated by three hosts named “hplkp182”, hplkp183”, and “hplkp184”, are being mastered with this set of options selected.

With reference to FIG. 9, it can be seen that the names of the PSI files do not appear—the host names appear instead at 918 and at 928.

The first pass determined that the PSI files collected from the two hosts “hplkp182” and “hplkp183” were compatible; accordingly they are assigned to a common depot named “Depot1” at 916, and their names both appear in the “Depot1” window 918. In the large window 906, the non-core operating system products from the three “compatible” PSI files appear on separate horizontal lines. Two of the products are installed on both of the two hosts (both host names appear in column 904 on the upper and lower of the three horizontal product data lines), while one product is installed only upon one machine (the product “Ignite-UX” shown on the middle horizontal line, a only one host name appearing in the column 914). Thus, the absence of one or more products from any given host does not render them incompatible to have their PSI files merged together.

The one PSI file not compatible with the others appears in an “Unassigned PSI Files” window at 902 (its host name appears in the window 928). Two products are listed, with their names in the column 924 and their product versions in the column 926. Note that the version number of the “100BASE-T” networking product is “B.11.00.22”, which differs from the version number of the same product on the remaining two computers which appear in the first line of column 912 in the window 906. This differing version number prevents the host “hplkp184” from having its PSI file merged with the others.

The maintainer, viewing this result, may decide to merge the PSI file for the host “hplkp184” into the depot “Depot1”. This can be done by clicking upon the host name in the window 928, selecting “Depot1” in the window 930, and then clicking the “Assign” display button 932 (with the mouse or pointer device). (Usually, the windows 928 and 930 will present more than one choice.) In response, the “Resolve Conflicts” screen display 1200 shown in FIG. 12 will appear, requiring the version number conflict for the 100BASE-T program to be resolved before this addition of the host “hplkp184” to the depot “Depot1” is permitted to occur. This, of course, could cause a new version of this program to be included in the depot created at step 136 (FIG. 1) for this platform to bring it into accord with the remaining platforms.

As other options, the maintainer may select a host name in the window 918 and then click the “unassign” pushbutton 920 to transfer the data for a host into the “Unassigned PSI Files” window 902. The maintainer may click the “Add Depot” pushbutton 934 to create a new Depot set, and then he or she can add “Unassigned PSI Files” to that new depot through the use of the “Assign” pushbutton 932 as just described, with the resulting new depot of PSI files appearing in a new window identical to the window 904. Likewise, the maintainer may depress the “Add Product” pushbutton 936 and thereby bring up the window interface 1100 (FIG. 11) which enables a new product specification, including name, version, and file sets to be added into any particular depot. And when done, the maintainer clicks on either the “Save Work” or the “Done” pushbutton 938 or 940 to either save the intermediate product without generating any merged PSI files (“Save Work”), with the option of later restoring the intermediate product and resuming work, or to save the final product in the form of a new or modified set of merged PSI file specifications in the work done archive 130.

Another option, not illustrated in FIGS. 8 and 9, is to have the specific model and number of processors of the computers treated just as if they, in combination, were a product and version of a product, so that each depot and each set of merged PSI files contains only machines that are “compatible” model machines having either single or multiple processors. In this case, the windows 922 and 906 would contain, in addition to computer program products and versions, also computer models and numbers of processors.

Another option is omitting from the merged PSI files all program patch lines of information, when any later program modification is to be done unprejudiced by what has gone before.

Finally, as an option, the column 908 in each of the depot windows 906 permits a check opposite any product to be removed (by a click of a mouse or other pointing device) signaling that the corresponding product should not be present when a depot is later generated for shared use on those machines.

Referring back to FIG. 7, after the second pass is completed, the merged PSI files 124 are created at step 706, and they are placed

Mastering—Pass One

FIG. 8 presents the steps carried out in phase one of the mastering process. First, at step 801, the user preferences are loaded or requested from the maintainer, as was explained above. Next, at step 802, copies of the PSI files are retrieved from the archive 116 and stored within the mastering program's memory. Product information is then retrieved from the PSI file sets, omitting all core operating system products so as not to clutter up the windows shown in FIGS. 9 through 12 with information that is not subject to user alteration. In this embodiment, this product information is taken from the file set information section, and not from the product information section, of each PSI file. At the option of the maintainer, hardware model and number of processor information is generated and is added to the product information, as has been explained.

Program control next advances into a repetitive process that is applied to each PSI file, beginning at the step 804, with branching back from the step 818 to the step 812 until all of the PSI file data has been processed. In the case of the first PSI file, since no depots have been created as yet, step 806 branches to the “create new depot” step 808, where the creation of a new “depot” or set of related PSI files is commenced. At step 810, the first PSI file's Host name and product names and versions, as well as model and number of processor information (if the user has elected this option) are placed into this first depot.

At step 818, since there are more PSI files to be processed, program control loops back to the step 812. Now a second, nested repetitive process is started during each pass of which the products and versions of another PSI file are compared to the product contents of an existing depot of PSI file product information. At step 812, the next depot is selected. Then at step 814, all the products and their versions in that depot are compared to all the products and their versions within the latest PSI file to locate any conflicts. If all the products and versions match (with a version mismatch being permitted within a range of versions specified by any relevant iPatch set expression 500 (FIG. 5)), with the exception of products present in either the latest PSI file but not present within the depot or not present within the latest PSI File but present within the Depot, then there is a match, and at step 810, this latest PSI file is added to the matching depot. But if no match is found after all of the depots nave been checked at step 816, then a new depot is created for this latest PSI file, which is incompatible with all previously examined PSI files.

Finally, after all the PSI files have been examined in this manner, at step 820 all of the depots that contain product information for only one PSI file are marked as “unassigned” and later on are displayed in the “Unassigned PSI Files” window 902, with the host names corresponding to these tentatively non-mergeable PSI files appearing in the window 928. Windows in the form of the window 904 are created and displayed for each of the other depots of PSI files, and their host names appear in windows in the form of the window 918, as has been explained.

Mastering—Second Pass

The second pass 900 of the mastering process, the semi-manual process whereby the maintainer checks and optionally rearranges the grouping of the PSI files for later merger using the window displays depicted in FIGS. 8 and 9, was described above in the portion of this description entitled “MASTERING SYSTEM.”

Mastering—Creating Merged PSI Files

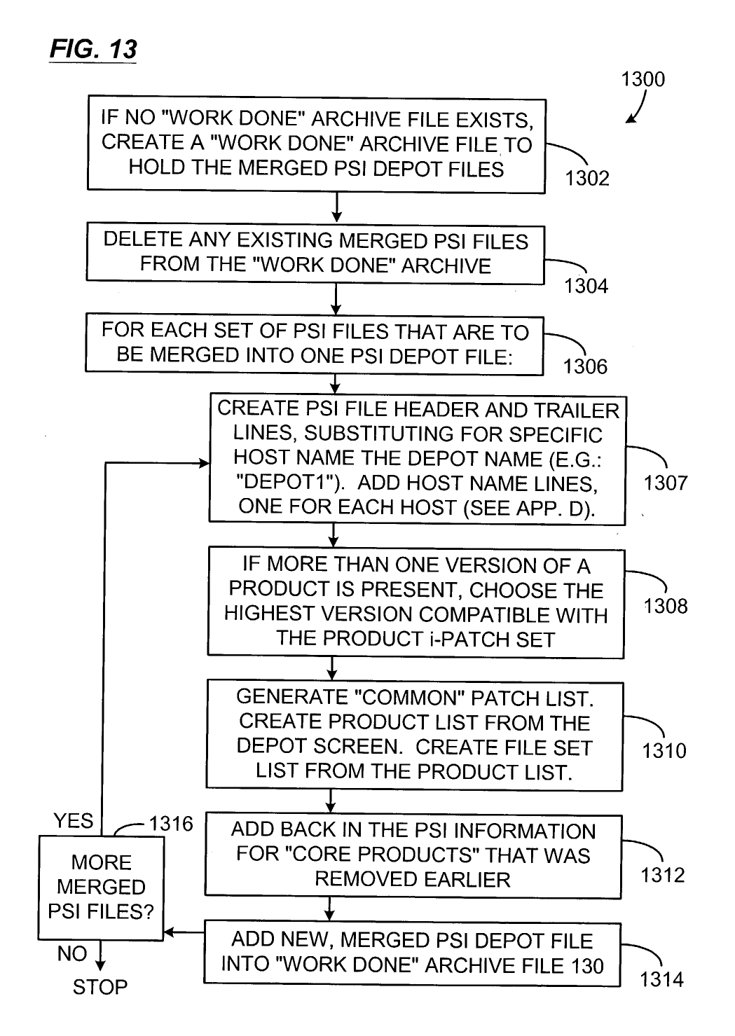

FIG. 13 presents the process of generating the merged PSI files 124 (FIG. 1) after the first and second passes of the mastering process have been completed. An illustrative merged PSI file is presented in Appendix D. It resulted from the merger of the two PSI files presented in Appendices A and B, and its contents correspond to the contents of the “Depot1” shown in the depot window 904 in FIG. 9.

The “work done” archive file 130 is first created at step 1302, if it does not yet exist. If it does exist, then at step 1304, any existing merged PSI files it contains are discarded to be replaced by those to be generated. Next, at step 1306, a repetitive process is commenced for each set of PSI files that are to be generated corresponding to each of the “depot” windows 904 (only one of which is shown in FIG. 9—one or more such windows will exist following the first and second pass).

For each depot of hosts: At step 1307, the PSI file header lines (for example, 204 in FIG. 2) and trailer lines (for example, 212 in FIG. 2) are generated. In each merged PSI file, the “<host nm>” data item contains, instead, the name of the depot, in Appendix D the default depot name “Depot1”. The two host names of the two computers “hplkp182” and “hplkp183” are not lost, but are preserved and presented in two dummy file set lines, which appear as follows in Appendix D:

SUADPR_DM1_hpIkp182 L2000/1 HP

SUADPR_DM2_hplkp183 L2000/1 HP

Here, “L2000” is the model number of the two computers, and the “/1” indicates the computers have only one CPU chip.

Next, at step 1308, if the use of iPatch expressions has permitted the presence of more than one version of a product, the highest version compatible with the iPatch expression is chosen instead of earlier versions for the product version, and multiple product lines with different version numbers are then merged into a single product line or application entry 220 (in FIG. 2). Next, at step 1310, optionally a “common” list of patch entries 210 (FIG. 2) common to all of the hosts is generated. But if this option is not selected, then the resulting merged PSI File will contain no patches whatsoever. The patch information is pulled from the original PSI files. But only patches that are commonly installed among all hosts are included in this embodiment. The file set entries 222 (also in FIG. 2) are created from the final product lists for each depot, using file set information retrieved from the original PSI files or supplied by the user (using the interface 110 shown in FIG. 11). At step 1312, the “core operating system products information,” pulled out of the analysis during the first pass 800 (step 802 in FIG. 8) and not manipulated during the second pass 900, are pulled out of the original PSI files and are added back into the new merged PSI files 124. Finally, at step 1314, the new, merged PSI files are placed into the work done archive file 130. This repetitive process continues at step 1316 until merged PSI files have been created corresponding to each and every depot set of hosts and products displayed in windows such as 904 (FIG. 10) during the second pass 900.

What is claimed is:

1. A method for simplifying the analysis and maintenance of program products installed on plural computers comprising:
gathering product version information from each of a plurality of computers of a similar type;
reorganizing the gathered information into one or more groups each containing the information gathered from a plurality of the computers, the computers within each group having installed thereon program products the versions of which are upgrade compatible; and
using the information in each group to guide the process of maintaining and upgrading the program products installed on the computers whose product information is within that group.

2. A method in accordance with claim 1 and further comprising: removing from a copy of the information gathered from each computer at least some information that does not normally vary from computer to computer; and
generating from the remaining gathered information and then displaying one or more displays indicating which versions of which products are installed on which computer.

3. A method in accordance with claim 2 and further comprising:
following the reorganizing step, generating from the gathered information within each group and displaying one or more displays for each group indicating which versions of which products are installed on each computer within each group.

4. A method in accordance with claim 1 and further comprising:
prior to the reorganizing step, removing from the information gathered from each computer at least some information that does not normally vary from computer to computer;
generating from the remaining gathered information and then displaying one or more displays indicating which versions of which products are installed on which computer;
following the reorganizing step, examining the one or more displays, and then reassigning the remaining information gathered from one or more of the computers to different groups to improve the grouping of the computers in cases where any upgrade incompatibility resulting from such a reassignment can be overcome by a product upgrade; and
prior to using the information, adding back to each group the information so removed from that gathered from each computer prior to using the information.

5. A method in accordance with claim 4 and further comprising:
following the reassigning step and prior to using the information, adjusting at least some of the product information for the computers reassigned as needed to reestablish product and version upgrade compatibility within each group.

6. A method in accordance with claim 1 and further comprising:
prior to the reorganizing step, removing from the information gathered from each computer at least some information that does not normally vary from computer to computer;
generating from the remaining gathered information and then displaying one or more displays indicating which versions of which products are installed on which computer;
following the reorganizing step, generating from the gathered information within each group and displaying one or more displays for each group indicating which versions of which products are installed on each computer within each group;
prior to using the information, examining one or more of the displays, and then reassigning the remaining information gathered from one or more of the computers to different groups to improve the grouping of the computers in cases where any upgrade incompatibility resulting from such a reassignment can be overcome by a product upgrade; and
prior to using the information, adding back to each group the information so removed from that gathered from each computer prior to using the information.

7. A method in accordance with claim 6 and further comprising:
following the reassigning step and prior to using the information, adjusting at least some of the product information for the computers reassigned as needed to reestablish product and version upgrade compatibility within each group.

8. A method in accordance with claim 1 and further comprising:
prior to the reorganizing step, removing from the information gathered from each computer at least some information that does not normally vary from computer to computer;
following the reorganizing step, generating from the remaining gathered information within each group and displaying one or more displays for each group indicating which versions of which products are installed on each computer within each group; and.
prior to using the information, adding back to each group the information so removed from that gathered from each computer.

9. A method in accordance with claim 8 and further comprising:
following the displaying step and prior to using the information, examining at least one of the displays, and then reassigning the remaining information gathered from one or more of the computers to different groups to improve the grouping of the computers in cases where any upgrade incompatibility resulting from such a reassignment can be overcome by a product upgrade.

10. A method in accordance with claim 9 and further comprising:
following the reassigning step and prior to using the information, adjusting at least some of the product information for the computers reassigned as needed to reestablish product and version upgrade compatibility within each group.

11. A system consolidation tool for simplifying the analysis and maintenance of multiple computers comprising:
a collection tool that gathers product specific information from each of a plurality of computers of a similar type;
a mastering system that reorganizes the gathered information into one or more information groups each containing information gathered from a plurality of computers, the computers whose information is included within each group having installed thereon program products the versions of which are upgrade compatible; and
a merged product specific information creator guided by the mastering system which generates product specific information for each group to replace the product specific information for each computer whose information is included within that group for use in maintaining and upgrading the computers in each group.

12. A system consolidation tool in accordance with claim 11 and further comprising:
a consistency and validation checker that checks the gathered product specific information.

13. A system consolidation tool in accordance with claim 11 and further comprising:
a filter which removes information relating to at least some products which do not normally vary from computer to computer from the gathered information; and
a product and patch table generator that transforms the gathered product specific information into tables indicating which product versions or patches or both are installed on which computers.

14. A system consolidation tool in accordance with claim 13 and further comprising:
an interactive display associated with the mastering system that, in conjunction with the tables, permits one to examine and to reassign the information gathered from one or more of the computers to different groups to improve the grouping of the computers in cases where upgrade incompatibility resulting from such a reassignment can be overcome by a product upgrade.

15. A system consolidation tool in accordance with claim 11 and further comprising:
a filter which removes information relating to at least some products which do not normally vary from computer to computer from the gathered information;
a product and patch table generator that transforms the gathered product specific information into tables indicating which product versions or patches or both are installed on which computers;
an assigner that can assign the information gathered from one or more of the computers to different groups to improve the grouping of the computers in cases where upgrade incompatibility resulting from such a reassignment can be overcome by a product upgrade; and
an information inserter which merges back into each group the information previously filtered out.

16. A system consolidation tool in accordance with claim 15 and further comprising:
a product version conflict resolver that adjusts at least some of the product specific information for computers reassigned as needed to reestablish product and version compatibility within each group.

17. A system consolidation tool in accordance with claim 1 and further comprising:
a filter which removes information relating to at least some products which do not normally vary from computer to computer from the gathered information;
an interactive display associated with the mastering system that permits one to examine and to reassign the information gathered from one or more of the computers to different groups to improve the grouping of the computers in cases where upgrade incompatibility resulting from such a reassignment can be overcome by a product upgrade; and
an information inserter which merges back into each group the information previously filtered out.

18. A system consolidation tool in accordance with claim 1 and further comprising:
a product version conflict resolver that adjusts at least some of the product specific information for computers reassigned as needed to reestablish product and version compatibility within each group.

19. A system consolidation tool in accordance with claim 1 and further comprising:
a filter which removes information relating to at least some products which do not normally vary from computer to computer from the gathered information;
an interactive display associated with the mastering system that permits the to examination of the information contents of the information groups; and
an information inserter which merges back into each group the information previously filtered out.

20. A system consolidation tool in accordance with claim 19 and further comprising:
an assigner that can assign the information gathered from one or more of the computers to different groups to improve the grouping of the computers in cases where upgrade incompatibility resulting from such a reassignment can be overcome by a product upgrade.

21. A system consolidation tool in accordance with claim 20 and further comprising:
a product version conflict resolver that adjusts at least some of the product specific information for computers reassigned as needed to reestablish product and version compatibility within each group.

22. A system consolidation tool for simplifying the analysis and maintenance of multiple computers comprising:
collection means for collecting product specific information from each of a plurality of computers;
mastering means for reorganizing the gathered information into one or more information groups each containing information gathered from a plurality of computers, the computers whose information is included within each group having installed thereon program products the versions of which are upgrade compatible; and
merged product specific information creation means for generating product specific information for each group of computers that replaces the product specific information for each computer gathered by the collection means.
